(19) United States
(12) Patent Application Publication
(10) Pub. No.: US 2013/0174009 A1
(43) Pub. Date: Jul. 4, 2013

(54) Personality-Based Web Pages

(71) Applicant: Althea Saldanha, Issaquah, WA (US)

(72) Inventor: Althea Saldanha, Issaquah, WA (US)

(73) Assignee: MICROSOFT CORPORATION, Redmond, WA (US)

(21) Appl. No.: 13/339,794

(22) Filed: Dec. 29, 2011

(51) Int. Cl. G06F 17/20; G06F 17/30

(52) U.S. Cl. 715/234; 707/706; 707/E17.108

(57) ABSTRACT

Various embodiments pertain to techniques that determine a perceived mood or personality that corresponds to a user and present a web page responsive to the determination. In some embodiments, the perceived mood or personality corresponding to a user can be determined according to a user's interaction with various colors presented on a web page. For example, responsive to a user hovering over a particular color presented on a web page, a perceived user characteristic, such as a perceived personality or mood corresponding to the user can be ascertained. A web page can be presented according to the perceived personality or mood. In various examples, style sheets can be used to present the web page in a way that corresponds to the perceived personality or mood corresponding to the user.

### BACKGROUND

Web pages, for example, search engine results pages (SERPs), are presented to users in a uniform manner, without regard for a user's particular learning style or personality traits. For example, some SERPs display results by presenting a link and a short synopsis of the website to which the link leads for each of the results. While this presentation is desired by some users, other users may prefer to see more information regarding the website or content while still other users may prefer to see only links to enable them to scan the SERP more quickly.

Additionally, web pages are presented according to a style sheet which, like the amount or type of information displayed, is independent of the user requesting the web page. The style sheet dictates, for example, the colors used for text and links, background colors, and fonts to be used to display the web page. A user's mood can be affected by the perception of these factors, and can cause a user to like or dislike a web page without consciously understanding why. By not adapting the presentation of web pages to individual users, websites can miss opportunities to appeal more strongly to users and secure a user's loyalty.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments pertain to techniques that make a determination associated with a perceived mood or personality that corresponds to a user and present a web page responsive to the determination. In some embodiments, the perceived mood or personality corresponding to a user can be determined according to a user's interaction with various colors presented on a web page. For example, responsive to a user hovering over a particular color presented on a web page, a correlation with a perceived personality or mood corresponding to the user can be drawn. A web page can be presented according to the perceived personality or mood. In various examples, style sheets can be used to present the web page in a way that corresponds to the personality or mood corresponding to the user. For example, if a user is perceived to be under stress, the style sheet can present the web page using colors associated with calmness. As another example, if a user is perceived to have a personality that correlates to seeing both sides of an issue, a SERF can be presented with more detail for each result than a SERP presented to a user perceived to have a personality that correlates to a desire to see more options and less detail for each option.

### BRIEF DESCRIPTION OF THE DRAWINGS

While the specification concludes with claims particularly pointing out and distinctly claiming the subject matter, it is believed that the embodiments will be better understood from the following description in conjunction with the accompanying figures, in which:

FIG. 1 illustrates an example operating environment in accordance with one or more embodiments;

FIGS. 2A-2B illustrate various search engine landing pages that can be presented to a user in accordance with one or more embodiments;

FIGS. 3A-3B illustrate various search engine results pages that can be presented to a user in accordance with one or more embodiments;

FIG. 4 is a flow chart depicting an example process for obtaining personality or mood information in accordance with one or more embodiments;

FIG. 5 is a flow chart depicting an example process for tailoring a web page based on a user's personality or mood in accordance with one or more embodiments; and

FIG. 6 illustrates an example device that can be used to implement one or more embodiments.

### DETAILED DESCRIPTION

### Overview

Various embodiments pertain to techniques that make a determination associated with a perceived mood or personality that corresponds to a user and present a web page responsive to the determination. In some embodiments, the perceived mood or personality corresponding to a user can be determined according to a user's interaction with various colors presented on a web page. For example, responsive to a user hovering over a particular color presented on a web page, a correlation with a perceived personality or mood corresponding to the user can be drawn. A web page can be presented according to the perceived personality or mood. In various examples, style sheets can be used to present the web page in a way that corresponds to the personality or mood corresponding to the user. For example, if a user is perceived to be under stress, the style sheet can present the web page using colors associated with calmness. As another example, if a user is perceived to have a personality that correlates to seeing both sides of an issue, a SERP can be presented with more detail for each result than a SERP presented to a user perceived to have a personality that correlates to a desire to see more options and less detail for each option.

In the discussion that follows, a section entitled “Example Operating Environment” describes an operating environment in accordance with one or more embodiments. Next, a section entitled “Example Embodiments” describes various embodiments of obtaining information regarding a mood, personality, or learning style of a user and tailoring a web page for the user based on the information. Finally, a section entitled “Example Device” describes an example device that can be used to implement one or more embodiments.

Consider now, an example operating environment in accordance with one or more embodiments.

Example Operating Environment

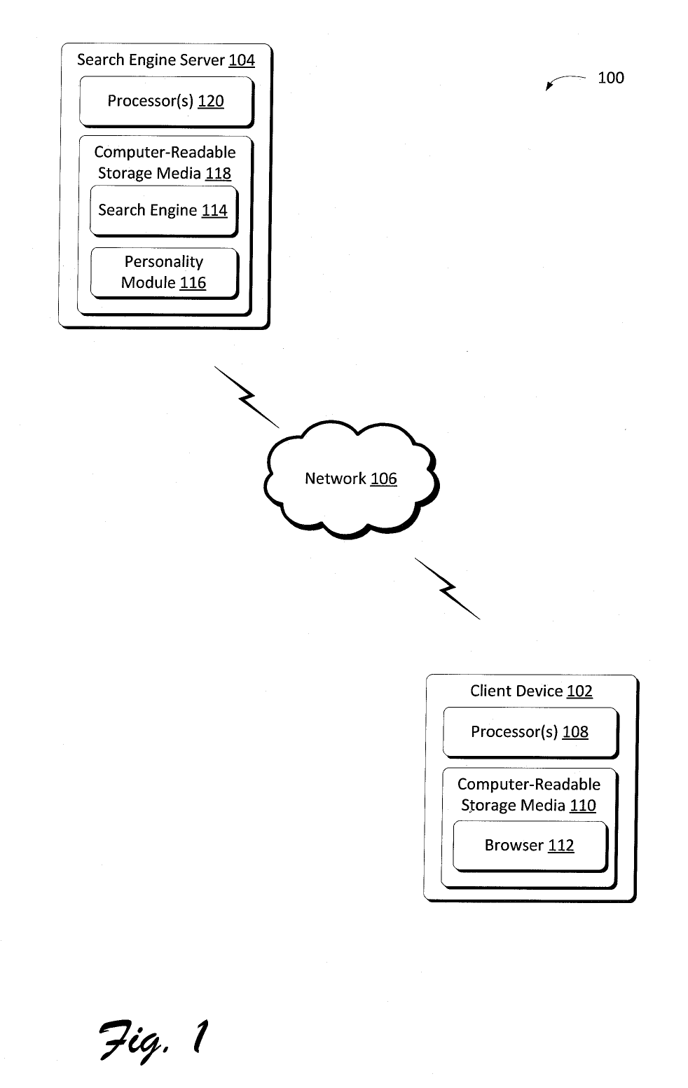

FIG. 1 is an illustration of an example environment 100 in accordance with one or more embodiments. Environment 100 includes a client device 102 communicatively coupled to a search engine server 104 through a network 106.

Client device 102 can include one or more processors 108 and computer-readable storage media 110. Client device 102 can be embodied as any suitable computing device such as, by way of example and not limitation, a desktop computer, a portable computer, a netbook, a handheld computer such as a personal digital assistant (PDA), a cell phone, and the like.

Computer-readable storage media 110 includes one or more software applications, which can include a software executable module in the form of a web browser 112. Browser 112 can receive content from and send content to other servers, such as search engine server 104, via network 106, such as the Internet. Such content can include any suitable type of content that can be received from and sent to websites hosted by servers. In various embodiments, browser 112 is configured to send a user query to a search engine 114 and cause a search engine results page (SERP) received from the search engine server 104 be displayed to a user via client device 102.

In various embodiments, search engine server 104 also includes a personality module 116 configured to correlate information about a user's interaction with a web page with a perceived user characteristic, such as a mood or personality corresponding to the user of the client device 102. In some embodiments, browser 112 can send information regarding a perceived mood or personality corresponding to a user to the search engine server 104 to cause the SERP to be presented according to the user's perceived mood or personality. For example, based on information sent by the browser 112, personality module 116 can correlate the information with a perception that a user is under stress and transmit information to browser 112 to cause the SERP to be displayed using colors associated with calmness. As another example, if a personality module 116 determines that a user is perceived to have a personality that correlates to seeing both sides of an issue, a SERP can be presented with more detail for each result than a SERP presented to a user perceived to have a personality that correlates to a desire to see more options and less detail for each option. A perceived mood or personality can be correlated with information regarding a user's interactions with a web page in various ways, examples of which are provided below.

Personality module 116, along with search engine 114, resides on computer-readable storage media 118 of search engine server 104. In addition to computer-readable storage media 118, search engine server 104 also includes one or more processors 120 configured to execute the software modules, e.g., search engine 114 and personality module 116, residing on computer-readable storage media 118. In various embodiments, search engine 114 receives and processes a user query and returns a listing of web search results corresponding to the query. The listing of web results can be presented, for example, as a listing of hyperlinks that, when a user selects one of the hyperlinks, redirects the user's browser to the resultant web page, which can be hosted on an additional server connected to the network 106.

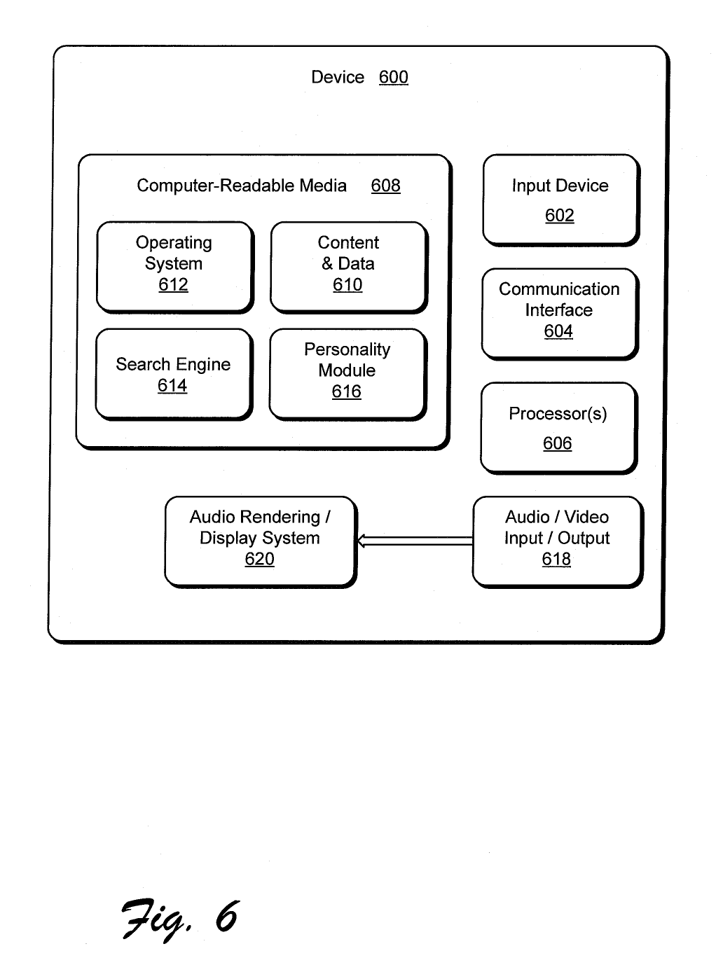

The computer-readable storage media included in each device or server can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 6.

Generally, any of the functions described herein can be implemented using software, firmware, hardware (e.g., fixed logic circuitry) or a combination of these implementations. The terms “module,” “functionality,” and “logic” as used herein generally represent software, firmware, hardware, or a combination thereof. In the case of a software implementation, the module, functionality, or logic represent program code that performs specified tasks when executed on a processor (e.g., CPU or CPUs). The program code can be stored in one or more computer-readable memory devices. The features of the user interface techniques described below are platform-independent, meaning that the techniques may be implemented on a variety of commercial computing platforms having a variety of processors.

Environment 100 is referenced by the following description of various embodiments in which web pages can be presented in view of a user's perceived personality or mood.

### Example Embodiments

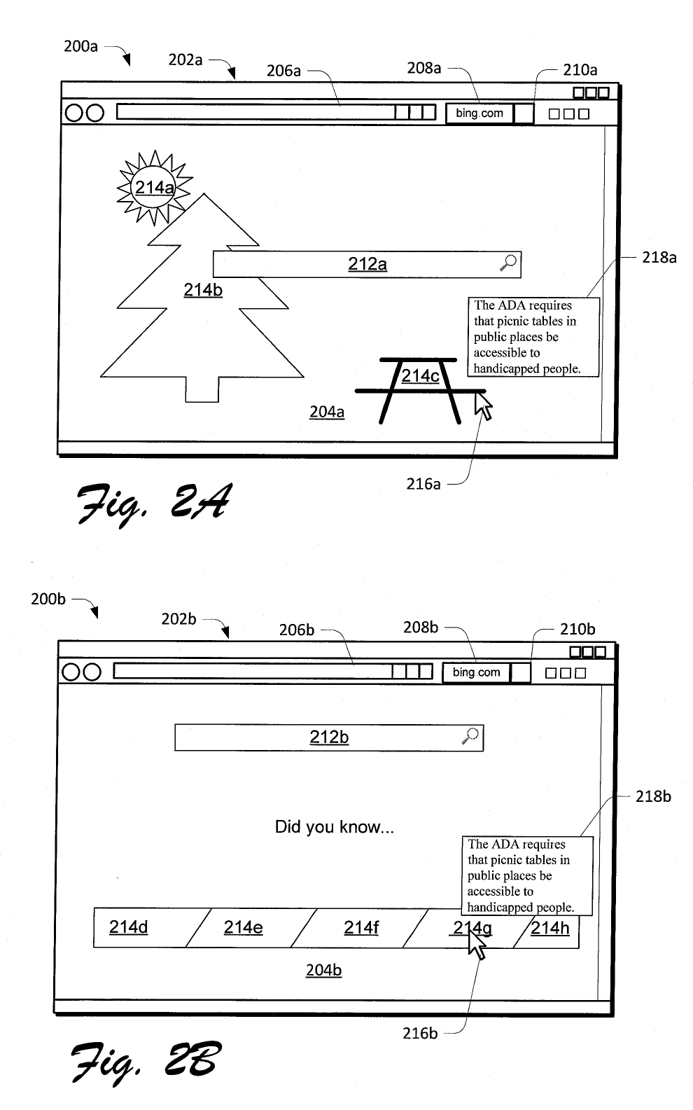

FIGS. 2A and 2B illustrate a web browser that has rendered various search engine landing pages in accordance with one or more embodiments. A version of the search engine landing page can be presented to a user, for example, when the user enters a uniform resource locator (URL) into an address bar or clicks on a link on another web page that leads to the search engine landing page. In the examples shown in each of FIGS. 2A and 2B, colored graphics are included as part of the search engine landing page and used to ascertain information regarding a mood or personality of a user.

In FIG. 2A, the web browser 200a includes a web browser user interface 202a which includes a content rendering area 204a configured to display web pages, such as the search engine landing page, to a user. The web browser user interface 202a also includes an address bar 206a, one or more tabs 208a, and a new tab button 210a for opening additional tabs. Other controls can be provided depending on the specific embodiment.

As shown in FIG. 2A, the search engine landing page displayed within content rendering area 204a includes a query box 212a and a graphic that, in this example, includes images of a sun 214a, a tree 214b, and a picnic table 214c. In some embodiments, when a user hovers a mouse indicator 216a over a portion of the graphic, such as picnic table 214c, a tooltip 218a can be displayed within content rendering area 204a. Various tooltips can be provided for a given search engine landing page. For example, a different tooltip can be displayed when a mouse indicator hovers over sun 214a, tree 214b, and picnic table 214c. Tooltip 218a can provide, for example, additional information or facts about the particular object shown in the graphic or a topic to which the graphic relates.

In various embodiments, tooltips are associated with portions of the graphic or web page that have varying colors. For example, as shown in FIG. 2A, tooltip 218a is associated with an image of a picnic table 214c that can be depicted as brown. Sun 214a can be depicted as orange-yellow, while tree 214b can be depicted as a dark green. In various embodiments, when a mouse indicator 216a hovers over a portion of the graphic or web page having a particular color, a user's affinity or preference for that color can be presumed. A user's main color preferences can be correlated to a perceived user characteristic, such as a perceived mood or personality of that user. For example, when mouse indicator 216a hovers over tree 214b, the user is presumed to prefer green. Furthermore, color personality tests have shown a user's color preferences can be mapped to moods or personality traits, e.g., people who prefer green tend to see both sides of an issue and tend to be idealistic.

In various embodiments, web browser 200a can keep track of which tooltips were displayed. In at least some of these embodiments, web browser 200a can also keep track of an order in which the tooltips were displayed. This can be performed in any suitable way. For example, when a tooltip is displayed, a page script configured to record the tooltip can be executed. In other embodiments, the location of the mouse indicator 216a within the content rendering area 204a can be ascertained and recorded to yield information regarding particular areas of the web page that the mouse indicator 216a hovered over. Alternately or in addition, other methods can be used to detect a mouse indicator 216a position or other user input (such as through a touch screen or natural user interface, for example) relative to a displayed graphic.

In various embodiments, a user can hover the mouse indicator 216a over one or more portions of the graphic to reveal associated tooltips before entering a user query into query box 212a and requesting a SERP. Information collected regarding which tooltips were displayed, the order in which the tooltips were displayed, colors over which the user hovered the mouse indicator, and/or locations of the mouse indicator can be transmitted to a search engine server along with the user query. In some embodiments, the information is transmitted to the search engine server independent of the user query.

FIG. 2B depicts an alternate example of a web browser 200b. As in FIG. 2A, the web browser 200b includes a web browser user interface 202b which includes a content rendering area 204b configured to display web pages, such as the search engine landing page, to a user. The web browser user interface 202b also includes an address bar 206b, one or more tabs 208b, and a new tab button 210b for opening additional tabs. Other controls can be provided depending on the specific embodiment.

The search engine landing page displayed within content rendering area 204b includes a query box 212b and a graphic that, in this example, includes a color scale having color blocks 214d, 214e, 214f, 214g, and 214h. In this example, when a user hovers a mouse indicator 216b over a color block, such as color block 214g, a tooltip 218b can be displayed within content rendering area 204b. Various tooltips can be provided for a given search engine landing page. For example, a different tooltip can be displayed when a mouse indicator hovers over each of the color blocks. Tooltip 218b can provide, for example, random facts or facts related to current events. In various embodiments, web browser 200b can keep track of which tooltips were displayed. In at least some of these embodiments, web browser 200b can also keep track of an order in which the tooltips were displayed. This can be performed in any suitable way, examples of which are provided above and below.

In various embodiments, a user can hover the mouse indicator 216b over one or more portions of the color block to reveal associated tooltips before entering a user query into query box 212b and requesting a SERP. Information collected regarding which tooltips were displayed, the order in which the tooltips were displayed, colors over which the user hovered the mouse indicator, and/or locations of the mouse indicator can be transmitted to a search engine server along with the user query. In some embodiments, the information can transmitted to the search engine server independent of the user query.

While FIGS. 2A and 2B describe obtaining information for correlation with a user's perceived personality or mood in association with a search engine landing page, it is to be understood that such information can be obtained from other types of web pages, such as news web pages, company-based web pages, e-commerce web pages, and the like. Regardless of the type of web page used to obtain information to be correlated with a user's perceived characteristics (e.g., personality or mood), once obtained, the information can be transmitted to a server for use in categorizing the user's perceived characteristics, such as a perceived personality or mood, and determining a page style to be used in presenting a subsequent web page to the user.

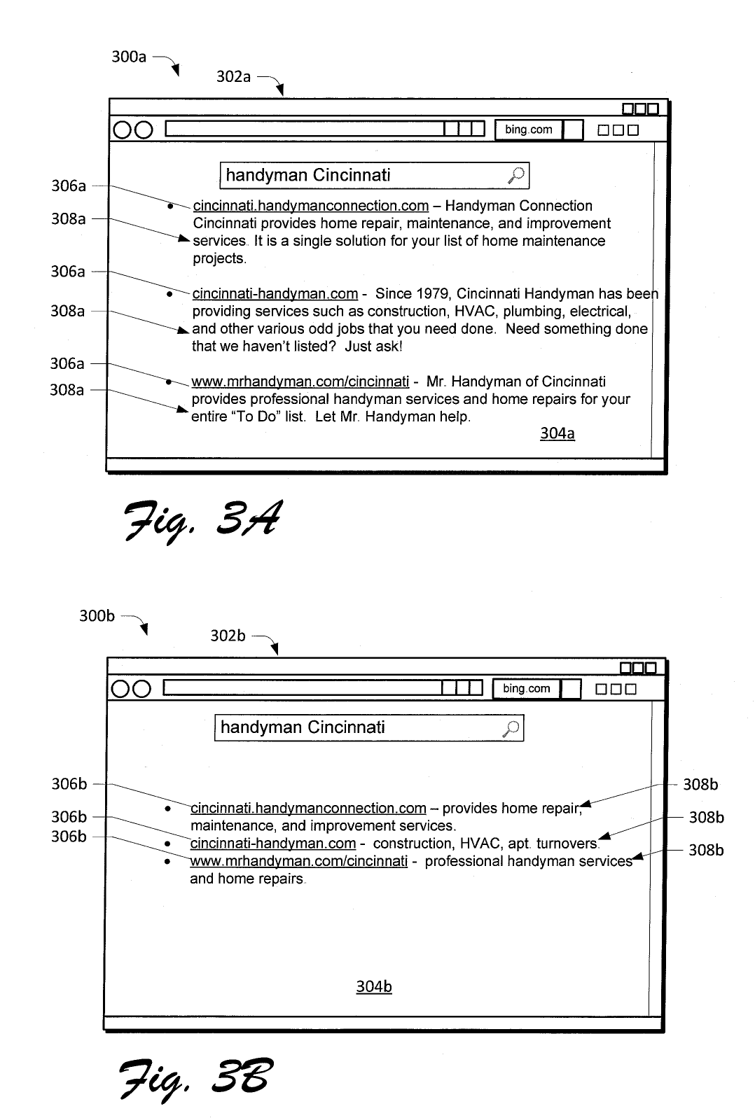

For example, assume a user has indicated a presumed preference towards the color blue by hovering a mouse indicator over a blue color block first, hovering a mouse indictor over a blue color block multiple times, or hovering a mouse indicator over a blue color block for an extended period of time. Information regarding the user's presumed preference for the color blue can be transmitted to the server, such as search engine server 104, and a personality module, such as personality module 116, can determine that, based on a correlation of a user's preference for the color blue with personality traits including loyalty, faithfulness, and a sense for order, logic, and rational thinking, that the user has these personality traits. The user's presumed sense for order, logic, and rational thinking can be further correlated with a preference in learning as much as possible without causing disruptions. These personality traits and presumed preferences can be utilized to tailor a web page to the user's perceived characteristics, such as personality, mood, and/or learning style. Examples of tailored web pages are shown in FIGS. 3A and 3B.

FIGS. 3A and 3B depict a web browser that has rendered various SERPs based on a user's perceived mood or personality in accordance with one or more embodiments. In particular, FIGS. 3A and 3B depict a SERP returned in response to a user query for users having different perceived personalities or moods, as determined in accordance with one or more embodiments.

In FIG. 3A, the web browser 300a includes a web browser user interface 302a which includes a content rendering area 304a configured to display web pages, such as the SERP, to a user. In various embodiments, code corresponding to the web page is received from the server, such as search engine server 104, and includes code corresponding to one or more web results 306a, one or more advertisements 308a to be displayed with the web results, and one or more styles to be utilized on the web page.

The style or styles can, in some embodiments, be described in cascading style sheets (CSS) or another style sheet language included in the code corresponding to the web page. The styles can include any presentation semantics, including by way of example and not limitation, the layout of a web page, colors utilized on the web page, fonts used on the web page, text alignment, borders, line spacing, or other typographical characteristics. In some embodiments, one or more styles can be selected according to a user's perceived mood or personality as presumed by a detected user color preference.

For example, if a user's interaction has indicated a perceived preference for the color blue, shades of blue and green can be used in the background of the web page to make the web page more visually appealing to the user. The use of blue and green can also be calming and soothing to the user, and can be used where a user is presumed to be under stress. Color preferences can be used in other ways to tailor the web page to the user without departing from the scope of various embodiments.

Additionally or alternately, the web page can be tailored in ways other than through the use of colors and/or styles. For example, the level of text and detail presented in the content rendering area can be tailored to the user's perceived personality or mood. For example, assume a user is presumed to see both sides of an issue and to have a preference for having details before making a decision based on the user's interactions with a web page. In order to accommodate such a user, a SERP such as is shown in content rendering area 304a can be presented.

The SERP displayed within content rendering area 304a includes a number of search engine results 306a selected in response to a user query. The particular number of search engine results 306a can vary depending on the particular embodiment, and can depend on various factors, such as the user query, a personality presumed for the user, or user-defined preferences, to name just a few. In various embodiments, each of the search engine results 306a can be presented as a link to a web page related to the user query. In addition to presenting a link, each of the search engine results 306a can include a snippet 308a of information taken from the linked web page. In various embodiments, the length of the snippet 308a can depend on the perceived personality, mood, or learning style of the user.

Like FIG. 3A, FIG. 3B includes a web browser 300b including a web browser user interface 302b which in turn includes a content rendering area 304b configured to display web pages, such as the SERP, to a user. Like that displayed in FIG. 3A, the SERP displayed within content rendering area 304b includes a number of search engine results 306b selected in response to a user query and presented as a link to a web page related to the user query. In addition to presenting a link, each of the search engine results 306b includes a snippet 308b of information taken from the linked web page. However, each snippet 308b is shorter compared to the snippets 308a in FIG. 3A, since the SERP displayed in FIG. 3A is tailored for a user presumed to prefer a lot of detail. As another example, snippets 308b can be shortened as a result of presuming that a particular user prefers not to have a lot of detail, but would prefer to see the results displayed as a simple list to facilitate quick review.

Content to be presented on the web page can be changed in order to tailor the web page to a user based on a perceived personality, mood, or learning style of the user, in any number of ways. A content item can be changed by providing one or more additional content items relating to a particular content item already included on the web page, removing a content item that a particular user is unlikely to be interested in, providing a different version of a content item (e.g., an excerpt or an unabridged version), or the like. For example, different versions of the web page can be stored by the server and a particular version can be selected according to the personality or mood associated with a user. As another example, a user who is presumed to prefer visuals, such as images, can be presented with a web page in which information is presented pictorially while a user who is presumed to enjoy reading can be presented with the information in text form. Other methods for varying content to be included can also be employed without departing from the scope of the presented embodiments. In some embodiments, advertisements selected to be displayed on a web page can be selected based on the user's perceived personality, mood, or learning style.

With the foregoing examples of web pages tailored to a perceived personality or mood for a particular user, consider the following examples of various processes for correlating user information with a presumed personality or mood for the user and presenting the web page.

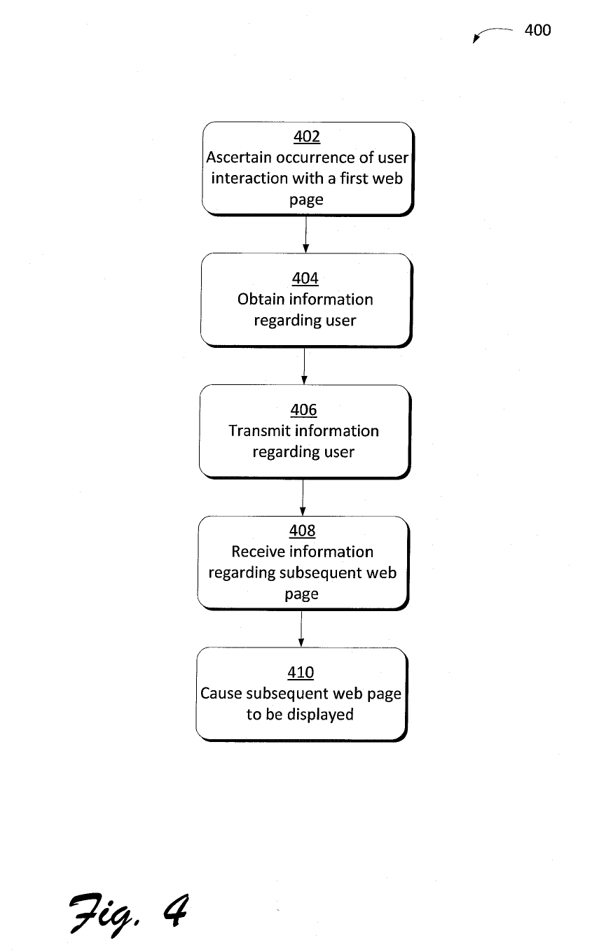

FIG. 4 depicts an example process 400 that can be conducted by a client device, for example, for obtaining user information for use in determining a perceived personality or mood corresponding to a user. Process 400 can be implemented in connection with any suitable hardware, software, firmware, or combination thereof. In at least some embodiments, the process can be implemented in software.

Block 402 ascertains occurrence of a user interaction with a first web page. This can be performed in any suitable way. For example, client device 102 can ascertain that a user hovered a mouse indicator over a portion of an image provided to a user as part of a landing page for a search engine. Other user inputs, such as inputs via a touch screen or natural user interface, can also be ascertained, depending on the particular embodiment.

Block 404 obtains information regarding the user interaction with the web page. This can be performed in any suitable way. For example, in some embodiments, block 404 can receive entry of a username and password for the web page that is associated with demographic and personality information for the user. Demographic, personality information, and other user preferences can be specifically input by the user, such as through the creation of a detailed user profile, or can be presumed based upon user interactions with various web pages and associated with the username. In various embodiments, alternatively or in addition to the user logging in, information regarding the user's interactions with the web page can be obtained. For example, when a user hovers a mouse indicator over an image or part of an image on the web page, for instance, to read text in a tooltip, a page script can record the location over which the user hovered the mouse indicator. In some embodiments, the order in which a user causes tooltips to be displayed and/or the color(s) over which the user hovers the mouse indicator can be recorded and used to ascertain information regarding the user.

Next, block 406 transmits information regarding the user. This can be performed in any suitable way. For example, client device 102 can transmit the information obtained by block 404 to search engine server 104 along with a user query. In various embodiments, the information regarding the user is transmitted with a request for a web page, although in other embodiments, the information regarding the user can be transmitted independent of a web page request.

Block 408 receives information regarding a subsequent web page. This can be performed in any suitable way. For example, client device 102 can receive code for a SERP from search engine server 104. Information regarding the subsequent web page can be received based at least in part on the information regarding the user transmitted by block 406. For example, the information transmitted by block 406 can be used to determine a perceived personality or mood for the user, and the perceived personality or mood can be associated with a selected subsequent web page to be received by client device 102.

Block 410 causes the subsequent web page to be displayed. This can be performed in any suitable way. For example, browser 112 can cause the SERP to be displayed for view by the user whose perceived personality or mood corresponds to the particular web page displayed.

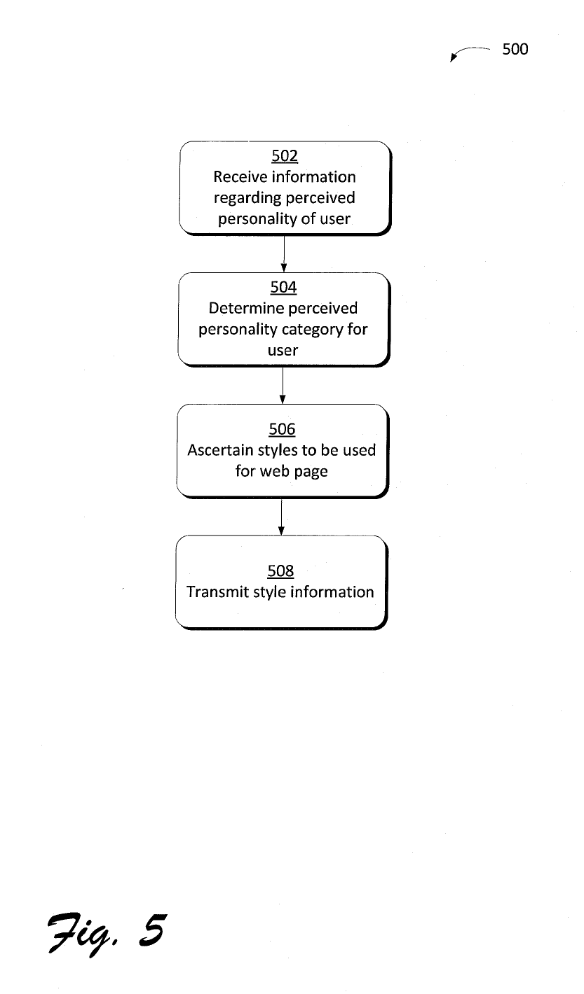

While FIG. 4 describes an example process for obtaining information regarding a user to be utilized in determining a user's perceived personality or mood and displaying a received web page, FIG. 5 illustrates an example process 500 for tailoring a web page according to the obtained information. The process can be implemented in connection with any suitable hardware, software, firmware, or combination thereof. In at least some embodiments, the process can be implemented in software, such as software on a server.

Block 502 receives information regarding a perceived personality of a user. This can be performed in any suitable way. For example, client device 102 can transmit the information along with, or in addition to, a user query entered into a search engine landing page. The information can be obtained in various ways, examples of which are provided above and below.

Block 504 determines a perceived personality category for the user based on the information received by block 502. This can be performed in any suitable way. For example, the information received by block 502 can be utilized along with a decision tree with one or more branches to determine a perceived personality category for the user. The number of available categories and the existence of subcategories can depend on the particular embodiment. For example, in some embodiments, users can be assigned to any one of two or more categories, while in other examples, users can additionally be assigned to a subcategory within the main category based on the information received. In various embodiments, a low number of categories can correspond to categories that cover a wide range of personalities while a larger number of categories can correspond to categories that are more specific and cover a more narrow range of personalities.

Next, block 506 ascertains one or more styles to be used for a web page according to the perceived personality category determined by block 504. This can be performed in any suitable way. For example, each available category can have a corresponding style sheet (sometimes called a cascading style sheet or CSS) that can be used to format the contents of a web page. The CSS can include, for example, properties for how to display hypertext markup language (HTML) elements, such as a size of HTML elements, various colors to be used on the web page, fonts, line spacing, indentation information, borders, and locations of HTML elements. In various embodiments, ascertaining one or more styles to be used can include selecting a particular version of a web page to be presented to a user from a number of versions of a web page. As another example, a category can include instructions on how long of a snippet can be provided after a link. Style sheets, web page versions, and snippet lengths are examples of various web page properties that can be ascertained according to the category for the perceived characteristic of the user. Other web page properties can vary depending on the category depending on the particular embodiment.

Block 508 transmits style information corresponding to the one or more styles to be used for the web page. This can be performed in any suitable way. For example, search engine server 104 can transmit style information as a CSS along with code for a SERP to client device 102. As another example, search engine server 104 can transmit code corresponding to a particular version of a web page to client device 102. The style information, once received by the client device, can be used to present a web page, such as a SERP, that is tailored to a perceived personality for a particular user.

Having described various techniques to determine a perceived mood or personality that corresponds to a user and present a web page responsive to the determination, consider an example system that can be used to implement one or more embodiments.

Example Device

FIG. 6 is a block diagram of an example device 600 that can be used to implement one or more embodiments. In one or more embodiments, device 600 can be implemented as a server, such as search engine server 104 in FIG. 1.

Device 600 includes input device 602 that may include Internet Protocol (IP) input devices as well as other input devices, such as a keyboard. Device 600 further includes communication interface 604 that can be implemented as any one or more of a wireless interface, any type of network interface, and as any other type of communication interface. A network interface provides a connection between device 600 and a communication network by which other electronic and computing devices can communicate data with device 600.

Device 600 also includes one or more processors 606 (e.g., any of microprocessors, controllers, and the like) which process various computer-executable instructions to control the operation of device 600 and to communicate with other electronic devices. Device 600 can be implemented with computer-readable media 608, such as one or more memory components, examples of which include random access memory (RAM) and non-volatile memory (e.g., any one or more of a read-only memory (ROM), flash memory, EPROM, EEPROM, etc.). A disk storage device may be implemented as any type of magnetic or optical storage device, such as a hard disk drive, a recordable and/or rewriteable compact disc (CD), any type of a digital versatile disc (DVD), and the like.

Computer-readable media 608 provides data storage to store content and data 610, as well as device executable modules and any other types of information and/or data related to operational aspects of device 600. One such configuration of a computer-readable medium is signal bearing medium and thus is configured to transmit the instructions (e.g., as a carrier wave) to the hardware of the computing device, such as via the network 106. The computer-readable medium may also be configured as a computer-readable storage medium and thus is not a signal bearing medium. Examples of a computer-readable storage medium include a random access memory (RAM), read-only memory (ROM), an optical disc, flash memory, hard disk memory, and other memory devices that may use magnetic, optical, and other techniques to store instructions and other data. The storage type computer-readable media are explicitly defined herein to exclude propagated data signals.

The various computer executable modules embodied on computer-readable media 608 are executable under the influence of processor 606. For example, an operating system 612 can be maintained as a computer executable module with the computer-readable media 608 and executed on processor 606. Device executable modules can also include a search engine 614 and a personality module 616 that operate as described above and below. Personality module 616 can be, for example, personality module 116.

Device 600 also includes an audio and/or video input/output 618 that provides audio and/or video data to an audio rendering and/or display system 620. The audio rendering and/or display system 620 can be implemented as integrated component(s) of the example device 600, and can include any components that process, display, and/or otherwise render audio, video, and image data.

As before, the blocks may be representative of modules that are configured to provide represented functionality. Further, any of the functions described herein can be implemented using software, firmware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer-readable storage devices. The features of the techniques described above are platform-independent, meaning that the techniques may be implemented on a variety of commercial computing platforms having a variety of processors.

While various embodiments have been described above, it should be understood that they have been presented by way of example, and not limitation. It will be apparent to persons skilled in the relevant art(s) that various changes in form and detail can be made therein without departing from the scope of the present disclosure. Thus, embodiments should not be limited by any of the above-described exemplary embodiments, but should be defined only in accordance with the following claims and their equivalents.

1. A computer-implemented method comprising: determining a perceived user characteristic based on user interaction with a web page that is displayed at a client device;
selecting a subsequent web page based on the perceived user characteristic; and
communicating the subsequent web page to the client device for display.

2. The computer-implemented method of claim 1, wherein user interaction comprises causing a tooltip to be displayed, hovering a mouse indicator over a region of the web page causing tooltips to be displayed in an order.

3. The computer-implemented method of claim 1, wherein the perceived user characteristic comprises a perceived personality, mood, or learning style of the user.

4. The computer-implemented method of claim 1, wherein the user interaction comprises entry of a username and password for the web page.

5. The computer-implemented method of claim 4, further comprising receiving information regarding user preferences based on a user input associated with the username and password.

6. The computer-implemented method of claim 1, wherein the user interaction comprises hovering a mouse indicator over a portion of the web page.

7. The computer-implemented method of claim 6, further comprising receiving information regarding the portion of the web page the mouse indicator hovered over.

8. The computer-implemented method of claim 7, wherein the portion of the web page comprises a graphic having a color, and the method further comprising obtaining information regarding the color of the graphic.

9. One or more computer-readable storage media comprising instructions that are executable to cause a device to perform a process comprising:
determining a perceived characteristic of a user based on information regarding the user;
determining, based on the perceived characteristic of the user, a category for the perceived characteristic of the user; and
ascertaining at least one web page property according to the category for the perceived characteristic of the user.

10. The one or more computer-readable storage media of claim 9, wherein ascertaining the at least one web page property selecting a version of a web page, selecting a style sheet for a web page, or selecting at least one content item for a web page.

11. The one or more computer-readable storage media of claim 9, wherein the information regarding the user comprises information that a tooltip was displayed, information regarding a location on a web page over which a mouse indicator hovered, or information regarding an order in which the user caused tooltips to be displayed.

12. The one or more computer-readable storage media of claim 11, wherein determining the perceived characteristic of the user includes determining a perceived personality, mood or learning style of the user.

13. The one or more computer-readable storage media of claim 9, wherein the information regarding the user comprises information regarding a color of a portion of a web page a mouse indicator hovered over.

14. The one or more computer-readable storage media of claim 13, wherein determining the perceived characteristic of the user includes determining a perceived personality, mood or learning style of the user based on the color of the portion of the web page the mouse indicator hovered over.

15. A device comprising:
a search engine configured to receive and process a user query and return a listing of web results corresponding to the user query to be displayed on a search engine results page; and
one or more processors to implement a personality module configured to:
determine a perceived personality of a user based on information regarding the user;
determine a personality category for the user based on the perceived personality of the user; and
ascertain at least one web page property for the search engine results page according to the personality category for the user.

16. The device of claim 15, wherein the information regarding the user comprises information that a tooltip was displayed, information regarding a location over which the user hovered a mouse indicator, or information regarding an order in which the user causes tooltips to be displayed.

17. The device of claim 16, wherein the personality module is further configured to determine the personality category for the user comprising a perceived mood or learning style of the user.

18. The device of claim 17, wherein the at least one web page property for the search engine results page comprises a version of the search engine results page, a style sheet for the search engine results page, or at least one content item for the search engine results page.

19. The device of claim 15, wherein the personality module is further configured to determine the personality category for the user comprising a perceived mood or learning style of the user.

20. The device of claim 15, wherein the at least one web page property for the search engine results page comprises a version of the search engine results page, a style sheet for the search engine results page, or at least one content item for the search engine results page.
